(19) United States
(12) Patent Application Publication
(10) Pub. No.: US 2016/0003456 A1
(43) Pub. Date: Jan. 7, 2016

(54) LIGHTING DEVICE

(71) Applicant: DONGGUAN JIASHENG LIGHTING TECHNOLOGY CO., LTD., GUANGDONG PROVINCE (CN)

(72) Inventor: Shuisheng XU, GUANGDONG PROVINCE (CN)

(21) Appl. No.: 14/527,875

(22) Filed: Oct. 30, 2014

(30) Foreign Application Priority Data
Jul. 4, 2014 (CN) 201420370267.5

(51) Int. Cl. F21V 21/005; F21V 23/00; F21V 29/70

(52) U.S. Cl. CPC F21V 21/005; F21V 29/70; F21V 23/003; F21Y 2103/003

(57) ABSTRACT

A lighting device comprises a PIR sensor, a control module and a plurality of LED modules. The PIR sensor and the LED modules are connected to the control module, respectively. The LED modules are provided around the PIR sensor. Each of the LED modules comprises a track bar assembly, an LED lamp and a plurality of track joints. Two ends of each of the track joints are provided on the LED lamp and the track bar assembly, respectively. The LED lamp is detachably fixed onto the track bar assembly via the track joints. The track bar assembly comprises a first track bar and two second track bars disposed on the inner side of the first track bar. The first track bar is arranged in a U-shape, while the two second track bars are disposed on two sidewalls of the first track bar, respectively.

### FIELD OF THE INVENTION

The present invention relates to a lighting device, and particularly to a lighting device.

### BACKGROUND OF THE INVENTION

With significant advantages of energy saving, environmentally friendly, long service life, no pollution to the environment, high efficiency, easy control and so forth, LED illumination has been more and more used for indoor illumination. However, at present, as the majority of LED lighting systems still employ conventional lamp control systems which allow control by mechanical switches only, without dimming and automatic switching functions. Due to low-level intelligence, when used in daily life, the LED lighting systems cause much inconvenience.

### SUMMARY OF THE INVENTION

Accordingly, in view of the deficiencies of the prior art, an object of the present invention is to provide a lighting device having high-level intelligence and high practicability.

A lighting device is provided, including a PIR sensor, a control module and a plurality of LED modules, the PIR sensor and the LED modules being connected to the control module, respectively, the LED modules being provided around the PIR sensor, each of the LED modules including a track bar assembly, an LED lamp and a plurality of track joints, two ends of each of the track joints being provided on the LED lamp and the track bar assembly, respectively, the LED lamp being detachably fixed onto the track bar assembly via the track joints, the track bar assembly including a first track bar and two second track bars disposed on the inner side of the first track bar, the first track bar being arranged in a U-shape, the two second track bars being disposed on two sidewalls of the first track bar, respectively.

Further, a clipping strip is convexly provided on the inner side of the first track bar, the clipping strip of the first track bar limiting the second track bars.

Further, each of the track joints includes a main body, a limiting joint pivoted onto the main body, and an adjusting lever having one end fixedly connected to the limiting joint, the adjusting lever driving the limiting joint to rotate with respect to the main body, the main body being fixedly connected to the LED lamp via a fixing member, two clipping sheets being provided at the upper end of the limiting joint, two slots being provided on the inside surfaces of the second track bars, the clipping sheets of the track bar assembly being clipped in the slots of the second track bars.

Further, the LED lamp includes a heat sink, an LED strip, a light transmittable shade, a driving device and a guard, the LED lamp bar being mounted on the bottom of the heat sink, the light transmittable shade being provided outside the LED lamp bar, the driving device and the guard being mounted on the top of the heat sink.

Further, an adjusting groove having a narrow inside and a wide outside is provided on the upper end face of the guard, an end of the adjusting lever close to the limiting joint being accommodated into the adjusting groove while an end of the adjusting lever away from the limiting joint extending out from the LED lamp, the adjusting lever being able to move in the adjusting groove.

Further, the track bar assembly further comprises a plurality of reinforcing bars, necks being provided on the second track bars, the reinforcing bars being disposed in the necks.

In conclusion, in the lighting device provided by the present invention, a plurality of LED modules are provided around the PIR sensor, and the plurality of LED modules are distributed corresponding to a corridor environment, so during operation, the control module controls an LED module corresponding to a corridor where a pedestrian appears to work, with high-level intelligence and high practicability.

### BRIEF DESCRIPTION OF THE DRAWINGS

FIG. 1 is a partial structure diagram of a lighting device according to the present invention;

FIG. 2 is a structure diagram when the LED lamp of FIG. 1 is fitted with a track joint;

FIG. 3 is a structure diagram of the track joint of FIG. 2;

FIG. 4 is a sectional view of the lighting device of FIG. 1; and

FIGS. 5-8 are assembly diagrams of a PIR sensor and an LED module when the lighting device of FIG. 1 is applied in different occasions.

### DETAILED DESCRIPTION OF THE PREFERRED EMBODIMENTS

In order to make the technical solutions of the present invention shown more clearly, the present invention will be further described as below with reference to the accompanying drawings.

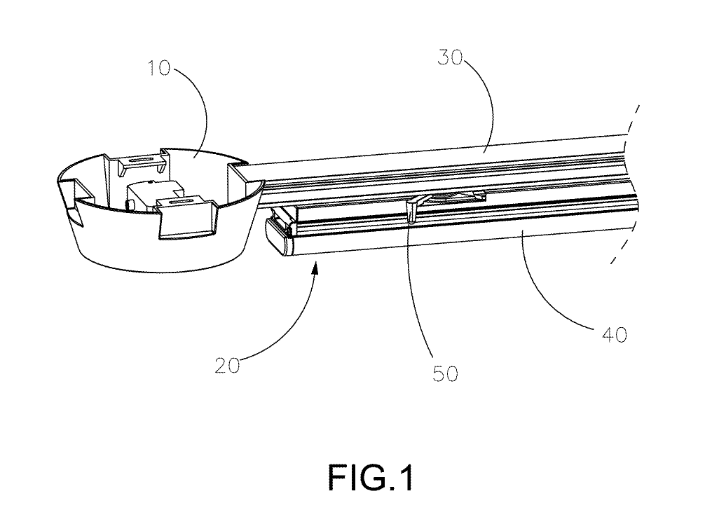

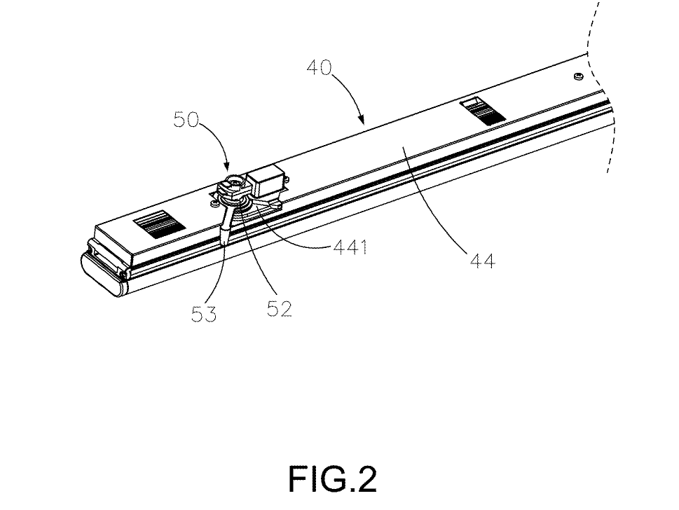

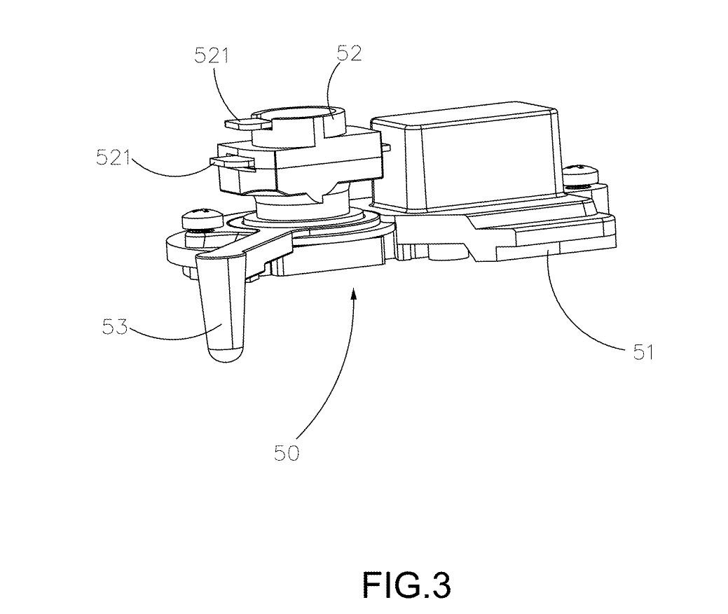

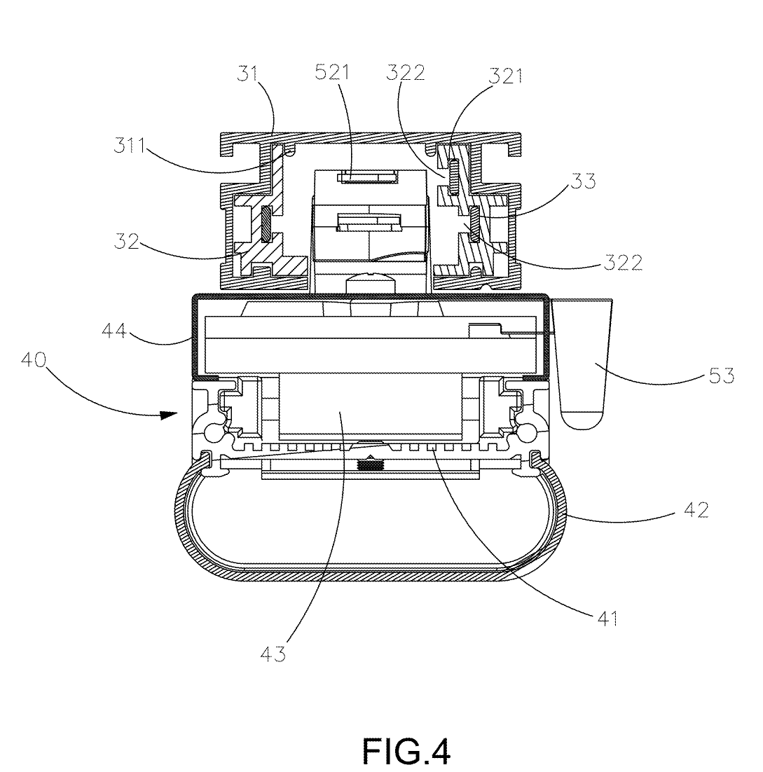

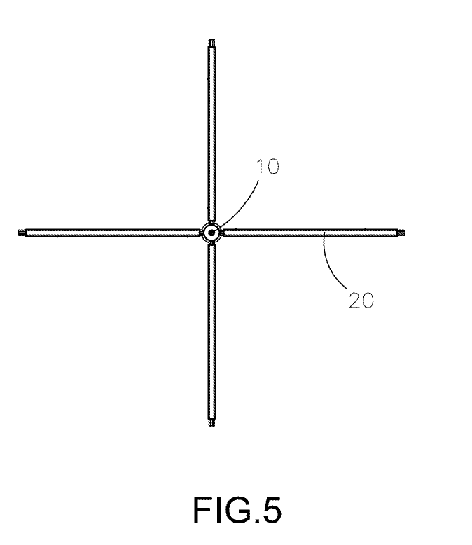

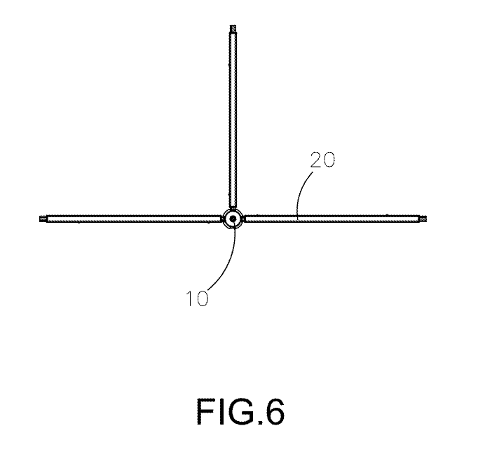

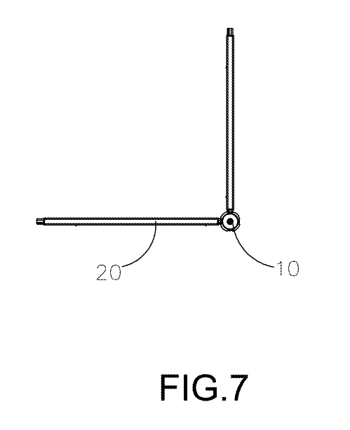

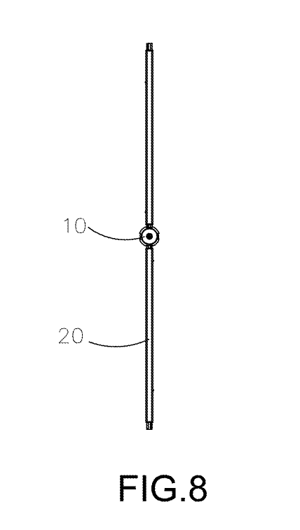

As illustrated in FIGS. 1-8, the present invention provides a lighting device mounted in corridors, at corners or in rooms so that corresponding corridor lamps will be turned on when there are pedestrians walking in the corridors or rooms in indifferent directions. The lighting device includes a PIR (Passive Infrared Sensor, also referred to as human thermal sensor) 10, a control module and a plurality of LED modules 20. The PIR sensor 10 and the LED modules 20 are connected to the control module, respectively. The LED modules 20 are provided around the PIR sensor 10. Each of the LED modules 20 includes a track bar assembly 30, an LED lamp 40 and a plurality of track joints 50. Two ends of each of the track joints 50 are provided on the LED lamp 40 and the track bar assembly 30, respectively. The LED lamp 40 is detachably fixed onto the track bar assembly 30 via the track joints 50.

The track bar assembly 30 includes a first track bar 31, two second track bars 31 disposed on the inner side of the first track bar 31, and a plurality of reinforcing bars 33 provided on the second track bars 32. The first track bar 31 is arranged in a U-shape. The two second track bars 32 are disposed on two sidewalls of the first track bar 31, respectively. A clipping strip 311 is convexly provided on the inner side of the first track bar 31. One side of the second track bar 32, open to the two sides of the first track bar 31, is disposed on the first track bar 31. The clipping strip 311 of the first track bar 31 limits the second track bars 32. Necks 321 are provided on the second track bars 32 in their extension direction. The reinforcing bars 33 are disposed in the necks 321. Two slots 322 are provided on the inside surface of one of the second track bars 32.

The LED lamp 40 includes a heat sink 41, an LED strip (not shown) mounted on the bottom of the heat sink 41, a light transmittable shade 42 covering the LED strip, a driving device 43 mounted on the top of the heat sink 41, and a guard 44. An adjusting groove 441 having a narrow inside and a wide outside is provided on the upper end face of the guard 44. The driving device 43 is communicated with an external circuit to supply power to the LED strip.

Each of the track joints 50 includes a main body 51, a limiting joint 52 pivoted onto the main body 51, and an adjusting lever 53 having one end fixedly connected to the limiting joint 52. The adjusting lever 53 drives the limiting joint 52 to rotate with respect to the main body 51. The main body 51 is fixedly connected to the guard 44 of the LED lamp via a fixing member. Two clipping sheets 521 corresponding to the slots 322 are provided at the upper end of the limiting joint 52.

During assembling the lighting device provided by the present utility mode, the main body 51 of the track bar assembly 30 is disposed on the LED lamp via a fixing member at first, an end of the adjusting lever 53 close to the limiting joint 52 is accommodated into the adjusting groove 441 while an end of the adjusting lever 53 away from the limiting joint 52 extends out from the LED lamp 40, and the adjusting lever 53 is able to move in the adjusting groove 441. The adjusting lever 53 is rotated such that the clipping sheets 521 of the track joints 50 become parallel to the main body 51; and then, the upper ends of the track joints 50 are placed onto the track bar assembly 30 and the first track bar 31, the adjusting lever 53 is rotated so that the limiting joint 52 of the track bar assembly 30 is allowed to rotate synchronously, and the clipping sheets 521 of the track bar assembly 30 are clipped into the slots 322 of the second track bars 32 so that the LED lamp and the track bar assembly 30 are fixed mutually. Finally, a plurality of LED modules 20 are fixedly disposed on the PIR sensor 10 via screws or in other ways. Preferably, the splicing mode of the plurality of LED modules 20 and the PIR sensor 10 may be selected according to the environment of a corridor. For example, for a corridor having corners formed in a T shape, an L shape, a line shape or a cross shape, a corresponding combination of the LED modules 20 distributed in a T shape, an L shape, a line shape or a cross shape is selected correspondingly. During operation, when the PIR sensor 10 detects that an infrared spectrum appears in the corridor on one side, that is, a pedestrian appears, and the corridor is of weak light, that is, at night, the PIR sensor 10 will feed back information to the control module. Then, the control module controls an LED module corresponding to a corridor where a pedestrian appears to work, until the pedestrian leaves the corridor.

In conclusion, in the lighting device provided by the present invention, a plurality of LED modules 20 are provided around the PIR sensor 10, and the plurality of LED modules 20 are distributed corresponding to the environment of a corridor, so during operation, the control module controls an LED module 20 corresponding to a corridor where a pedestrian appears to work, with high-level intelligence and high practicability.

The foregoing embodiment merely shows an implementation manner of the present invention. Although has been described specifically in details, the foregoing embodiment shall not be interpreted as limitations to the patent scope of the present invention. It is to be noted that, for a person of ordinary skill in the art, various variations and improvements may be made without departing from the idea of the present invention, and these variations and improvements all shall fall into the protection scope of the present invention. Therefore, the protection scope of the present invention shall be subject to the appended claims.

What is claimed is:

1. A lighting device, comprising a PIR sensor, a control module and a plurality of LED modules, the PIR sensor and the LED modules being connected to the control module, respectively, the LED modules being provided around the PIR sensor, each of the LED modules comprising a track bar assembly, an LED lamp and a plurality of track joints, two ends of each of the track joints being provided on the LED lamp and the track bar assembly, respectively, the LED lamp being detachably fixed onto the track bar assembly via the track joints, the track bar assembly comprising a first track bar and two second track bars disposed on the inner side of the first track bar, the first track bar being arranged in a U-shape, the two second track bars being disposed on two sidewalls of the first track bar, respectively.

2. The lighting device according to claim 1, wherein a clipping strip is convexly provided on the inner side of the first track bar, the clipping strip of the first track bar limiting the second track bars.

3. The lighting device according to claim 1, wherein each of the track joints comprises a main body, a limiting joint pivoted onto the main body, and an adjusting lever having one end fixedly connected to the limiting joint, the adjusting lever driving the limiting joint to rotate with respect to the main body, the main body being fixedly connected to the LED lamp via a fixing member, two clipping sheets being provided at the upper end of the limiting joint, two slots being provided on the inside surfaces of the second track bars, the clipping sheets of the track bar assembly being clipped in the slots of the second track bars.

4. The lighting device according to claim 3, wherein the LED lamp comprises a heat sink, an LED strip, a light transmittable shade, a driving device and a guard, the LED lamp bar being mounted on the bottom of the heat sink, the light transmittable shade being provided outside the LED lamp bar, the driving device and the guard being mounted on the top of the heat sink.

5. The lighting device according to claim 4, wherein an adjusting groove having a narrow inside and a wide outside is provided on the upper end face of the guard, an end of the adjusting lever close to the limiting joint being accommodated into the adjusting groove while an end of the adjusting lever away from the limiting joint extending out from the LED lamp, the adjusting lever being able to move in the adjusting groove.

6. The lighting device according to claim 1, wherein the track bar assembly further comprises a plurality of reinforcing bars, necks being provided on the second track bars, the reinforcing bars being disposed in the necks.
